(19) United States
(12) Patent Application Publication
(10) Pub. No.: US 2015/0352485 A1
(43) Pub. Date: Dec. 10, 2015

(54) Liquid Distributor in a Separation Column

(71) Applicant: AIR PRODUCTS AND CHEMICALS, INC., Allentown, PA (US)

(72) Inventors: Vladimir Yliy Gershtein, Allentown, PA (US); Patrick Alan Houghton, Emmaus, PA (US); Jonathan Wilson, Chesire (GB)

(73) Assignee: AIR PRODUCTS AND CHEMICALS, INC., Allentown, PA (US)

(21) Appl. No.: 14/749,769

(22) Filed: Jun. 25, 2015

(51) Int. Cl. B01D 53/18; B01F 3/04

(52) U.S. Cl. CPC B01D 53/185; B01F 3/04078

(57) ABSTRACT

A distributor for distribution of a liquid in a mass transfer column and method for distribution, including a first riser, a first plurality of liquid distribution apertures positioned adjacent to and at a first distance from a first edge of the first riser; a second plurality of liquid distribution apertures positioned adjacent to and at a second distance from a second edge of the first riser; a second riser; a third plurality of liquid distribution apertures positioned adjacent to and at a third distance from a first edge of the second riser; and a fourth plurality of liquid distribution apertures positioned adjacent to and at a fourth distance from a second edge of the second one riser; wherein the second plurality of liquid distribution apertures are adjacent to and at a fifth distance from third plurality of liquid distribution apertures.

### BACKGROUND

To achieve high efficiencies in mass transfer columns (e.g., air separation columns), it is well established that uniform liquid distribution in a packing bed is critical. Uniform liquid distribution leads to efficient mass transfer in the packing bed. Thus, it became the industry standard to design mass transfer columns and devices to promote uniform liquid distribution.

For exemplary purposes, a traditional mass transfer column section 100 is illustrated in FIG. 1 that uses countercurrent flow of a liquid and a vapor for mass transfer. The liquid falls down the mass transfer column as a result of gravity and the vapor rises up the mass transfer column as a result of an established pressure gradient inside. The result is that mass transfer takes place inside the column.

A typical mass transfer column, such as an air separation column, is divided into number of zones or sections 100 where each zone or section 100 is bounded by a mass transfer device such as, for example, a packing bed or packing 104, from the bottom, a liquid distributor 110, for example, from the top, and the mass transfer column walls 102 on the sides. Between the packing 104 and the distributor 110 is a space or spacing 108 between the bottom surface 126 of the liquid distributor 110 and the top surface 106 of the packing 104 where vapor 120 ascends upward from the packing 104 and liquid 116 falls freely downward from the liquid distributor 110.

A typical liquid distributor 110 contains both vapor and liquid passages for vapor and liquid collection and distribution. The vapor passages, riser passages, or risers 112, characterized by its riser edges 124, are used for the ascending vapor 120 to pass through the liquid distributor 110 into the next column section. Liquid collectors (not shown) are located on the top of the liquid distributor 110. The liquid collector and liquid distributor 110 are typically designed to maintain a desired level of liquid 116 and to provide a desired, usually even liquid distribution across the surface of the liquid distributor 110 and, therefore, across the column cross-sectional area. The purpose of the liquid distributor 110 is to distribute the liquid 116 uniformly on the packing surface 106. A series of liquid distribution apertures or holes 114 are placed in the liquid distributor 110 for the liquid 116 to pass through under hydrostatic pressure. The liquid distribution apertures or holes 114 may be of equal or different diameters depending on the mass transfer column size, specific zone or section design, position on the liquid distributor surface, etc. In addition, the liquid distribution apertures or holes 114 may be organized in regular or irregular arrays. The liquid distribution apertures or holes 114 may be placed at the bottom of the distributor body or at the trough vertical walls, etc.

Liquid streams of droplets 118 form after passing through the liquid distribution apertures or holes 114 of the liquid distributor 110 and the streams of droplets 118 fall from the liquid distributor 110 through the spacing 108 creating streams of droplets 118 or liquid streams. In general, the liquid streams or droplets 118 created may vary in size and may have different initial velocities. The droplet sizes are defined by the diameter of the liquid distribution apertures or holes 114, by the liquid initial velocity, and by the liquid physical properties (i.e., density, viscosity, etc.). The liquid initial velocity is defined by the number of liquid distribution apertures or holes 114, the diameter of the liquid distribution apertures or holes 114, and the level of the liquid 116 above the liquid distributor 110. The droplets 118 fall down freely against the ascending vapor 120 in the spacing 108.

The packing or packing bed 104 is designed to accept the liquid 116 from the liquid distributor 110 and to distribute the ascending vapor stream 120 evenly across the column cross section 102. Therefore, one may assume that the ascending vapor 120 ascends evenly up to the liquid distributor 110 where it shall split into a series of streams penetrating the open area of the risers 112 organized across the surface of the liquid distributor 110.

The split of the ascending vapor 120 into a series of streams may not be uniform, however, and depends primarily on the open area, geometry, and position of the risers 112. As illustrated in FIG. 2, as the vapor streams 120 ascend through the spacing 108, the vapor streams 120 begin to accelerate and turn towards the open area of the risers 112 where the vapor streams 120 may escape into the next column section, for example. These turning vapor streams 122 create a force directed towards the center of the open area of the risers 112 and on the falling liquid streams or droplets 118. In the traditional column section 102, the falling liquid or droplet 118 may experience the impact of the force produced by the ascending turning vapor streams 122 the moment the droplet 118 exits the liquid distributor 110 into the spacing 108. The interaction between turning vapor stream 122 and the falling droplets 118 influences the intended trajectory of the falling droplets 118 (i.e., through deflection of the falling droplets 118). Any significant change from the intended trajectory of the falling droplets 118, and thus, the droplets' 118 intended target(s) on the packing surface 106, may lead to liquid maldistribution at the packing surface 106 and as a result, poor performance of the mass transfer column section 100.

The force acting on the droplets may be different in the vicinity of different risers since the vapor stream may split differently as mentioned above. Typically, the ascending vapor begins its split into different streams in the space between the top of the packing surface 106 and the underside of the liquid distributor 126 (i.e. in the spacing 108). A droplet trajectory will depend on the droplet mass, its initial velocity, the position of the liquid distribution apertures or holes relative to the riser edge, and the droplet affected residence time (i.e., the time when the droplet 118 is in the spacing 108 under the influence of the force from the turning vapor stream 122).

Significant deflection of the droplet 118 may occur from a desired fall position if the droplet 118 is experiencing a force from the turning vapor stream 122, for example, at the very top of the spacing 108 and/or if the droplet 118 forms at the liquid distribution aperture or hole 114 positioned close to the riser edge 124. The velocity of the rising vapor streams 120, including the turning vapor streams 122, increase as such vapor streams approach the riser 112 and the velocity of such vapor streams are at their maximum inside the riser 112. Therefore, the closer the vapor streams are to the edge of the riser 112, the higher their velocity and, thus, the stronger the force is impacting the droplets 118. Further, as vapor and liquid throughput is increased in the mass transfer column, liquid droplet deflection will increase.

There are several ways to minimize liquid deflection in the mass transfer column. The first way to minimize liquid deflection in the mass transfer column is to minimize the spacing 108 height (H) defined as the distance between the bottom surface 126 of the liquid distributor 110 and the top surface 106 of the packing 104. Having a smaller spacing height (H) results in a shorter affected droplet residence time (ADRT) of the falling liquid in that spacing 108 and, therefore, may result in less overall liquid deflection from the desired fall position at the packing surface. The affected droplet residence time (ADRT) is calculated by dividing the spacing where the droplets are affected by the turning vapors streams (H_{AFFECTED}) by the average droplet velocity (V_{AVEDROPLET}) or:

ADRT=H_{AFFECTED}/V_{AVEDROPLET}.

Unfortunately, minimizing the spacing 108 height (H) often has limits due to a variety of different factors related to fabrication of the mass transfer devices and liquid distributors.

A second way to minimize liquid deflection in the mass transfer column is to reduce the vapor flow rate. This option may greatly impact the force deflecting the liquid streams as shown in FIG. 3, however, this option may not be desirable, especially when products of separation are of great demand and the mass transfer column is forced to operate at its maximum capacity.

A third way to minimize liquid deflection in the mass transfer column is to reduce the ascending vapor velocity inside the riser 112 by increasing the riser open area while keeping the vapor flow rate constant. This approach utilizes less space for horizontal liquid flow resulting in narrower liquid troughs (not shown) with higher liquid velocities in the troughs and, therefore, may impact liquid distribution at the top of the liquid distributor 110. Poor liquid distribution in the distributor troughs will make liquid maldistribution even worse at the packing surface 106. In addition, narrower troughs may demand positioning the rows of liquid distribution apertures or holes 114 closer to the riser edges 124. Such positioning of the liquid distribution apertures or holes 114 may lead to an increased liquid stream deflection and, therefore, may result in even greater liquid maldistribution on the packing surface 106.

A fourth way to minimize liquid deflection in the mass transfer column is to increase the droplet size of the liquid and to increase the liquid droplet initial velocity. These two approaches are interdependent. Indeed, an increase in the droplet size requires larger diameter liquid distribution apertures or holes 114, which by itself may reduce the liquid level above the liquid distributor 110, thereby leading to reduced initial droplet velocity in the spacing. While it is possible to increase the size of the liquid distribution apertures or holes 114 and keep the liquid level above the liquid distributor 110 constant by reducing the number of liquid distribution apertures or holes 114 on the liquid distributor 110, this may lead to a liquid distributor design with too few aperture or holes 114, which by itself may impact the uniformity of liquid distribution on the packing surface 106 and the overall efficiency of the mass transfer column. A simple increase in the liquid level to increase initial liquid velocity may influence the column design (i.e., forcing an increase in column height). Typically, this option is also undesirable in most cases.

Traditional liquid distributor designs may be found in, for example, the following publications: U.S. Pat. Nos. 6,293,526; 6,059,272; 6,395,139; 5,785,900; 5,132,055; 5,868,970; 6,086,055; EP 0972551; and WO 02/083260.

Disclosure and discussion of the problems associated with uniform liquid distribution on the mass transfer device surface or so called packing surface are somewhat limited. This may be because of the well-known, but incorrect, assumption or belief that if a liquid is distributed uniformly at the point where liquid leaves the liquid distributor, the liquid will be distributed uniformly on the surface of a mass transfer device or packing. It is customary to assume that the uniform distribution of the holes on the liquid distributor provides the same uniform liquid distribution at the mass transfer device surface, (i.e., where the liquid entered the packing surface).

Thus, there is a need in the art for an improved liquid distributor design that permits sustaining performance in a mass transfer column at high production rates by minimizing liquid maldistribution on the packing surface and associated method of use. Such methods and design shall minimize droplet deflection in the spaces between liquid distributors and the packing surfaces for different column zones.

### SUMMARY

The disclosed embodiments satisfy the need in the art by providing both a system and method to facilitate liquid distribution over a surface of mass transfer devices, in particular in air separation columns where uniform distribution of the falling liquid is critical and has a significant impact on the separation device's efficiency. Aspects of the present invention are applicable to all style distributors, including, but not limited to, narrow trough style and thick plate style liquid distributors, but are particularly beneficial for wide trough style liquid distributors or in the case where a high density hole pattern is used, for example, more than 200 holes per square meter of the mass transfer device area. Importantly, liquid deflection becomes a particularly important issue in mass transfer devices comprising high vapor flow rates and using high capacity structured packing.

The disclosed embodiments actually utilize the liquid deflection to achieve uniform or close to uniform liquid distribution at the packing surface. Applicants found that since at least some liquid deflection is an inevitable phenomenon it may be easier to use the liquid deflection rather than to eliminate it.

In one embodiment a liquid distributor for distribution of a liquid in a mass transfer column is disclosed, comprising: a first riser, having a first riser width; a first plurality of liquid distribution apertures positioned adjacent to and at a first distance from a first edge of the first riser; a second plurality of liquid distribution apertures positioned adjacent to and at a second distance from a second edge of the first riser; a second riser, having a second riser width; a third plurality of liquid distribution apertures positioned adjacent to and at a third distance from a first edge of the second riser; and a fourth plurality of liquid distribution apertures positioned adjacent to and at a fourth distance from a second edge of the second one riser; wherein the second plurality of liquid distribution apertures are adjacent to and at a fifth distance from third plurality of liquid distribution apertures, and wherein the fifth distance between the second and third plurality of liquid distribution apertures is less than the first distance, the second distance, and the first riser width combined.

In another embodiment, a method for the distribution of a liquid in a mass transfer column is disclosed, comprising the steps of: introducing the liquid into an upper portion of the mass transfer column; positioning within the mass transfer column as least one mass transfer column section; positioning within the at least one mass transfer column section a liquid distributor to receive a downwardly flowing stream of liquid and an upwardly flowing stream of vapor, the liquid distributor comprising: a first riser, having a first riser width; a first plurality of liquid distribution apertures positioned adjacent to and at a first distance from a first edge of the first riser; a second plurality of liquid distribution apertures positioned adjacent to and at a second distance from a second edge of the first riser; a second riser, having a second riser width; a third plurality of liquid distribution apertures positioned adjacent to and at a third distance from a first edge of the second riser; and a fourth plurality of liquid distribution apertures positioned adjacent to and at a fourth distance from a second edge of the second one riser; wherein the second plurality of liquid distribution apertures are adjacent to and at a fifth distance from third plurality of liquid distribution apertures, and wherein the fifth distance between the second and third plurality of liquid distribution apertures is less than the first distance, the second distance, and the first riser width combined, collecting the downwardly flowing stream of liquid from the upper portion of the mass transfer column on the first surface of the liquid distributor; passing the upwardly flowing stream of vapor from the lower portion of the mass transfer column through the risers of the liquid distributor; and distributing the downwardly flowing stream of liquid from at least one liquid distribution aperture in the liquid distributor on to a packing.

### BRIEF DESCRIPTION OF SEVERAL VIEWS OF THE DRAWINGS

The foregoing summary, as well as the following detailed description of exemplary embodiments, is better understood when read in conjunction with the appended drawings. For the purpose of illustrating embodiments, there is shown in the drawings exemplary constructions; however, the invention is not limited to the specific methods and instrumentalities disclosed. In the drawings:

FIG. 1 is cross-sectional view of a traditional mass transfer column section;

FIG. 2 is sectional view of the traditional mass transfer column section of FIG. 1;

FIG. 3 is a graphical representation illustrating droplet deflections as a function of vapor and liquid velocities;

FIG. 4 is a cross-sectional view of a mass transfer column section in accordance with one embodiment of the present invention;

FIG. 5 is a cross-sectional view of a mass transfer column section in accordance with one embodiment of the present invention;

FIG. 6A is a cross-sectional view of a liquid distributor in accordance with one embodiment of the present invention;

FIG. 6B is a sectional view of the liquid distributor of FIG. 6A in accordance with one embodiment of the present invention;

FIG. 7 is a graphical representation illustrating liquid deflection of various relative liquid aperture locations away from the riser edge in accordance with one embodiment of the present invention;

FIG. 8 is a graphical representation illustrating a comparison of liquid deflection in liquid distributors having both uniform and non-uniform holes patterns;

FIG. 9 is a graphical representation illustrating liquid deviation from the desired fall position on the packing surface in liquid distributors having both uniform and non-uniform holes patterns;

FIG. 10 is a graphical representation illustrating the differences in deviation from the target position for a spacing height H as the hole shift ratio (Y2/Y1) is changed; and

FIG. 11 is a graphical representation illustrating differences in deviation from the target position for a spacing height 0.5(H) as the hole shift ratio (Y2/Y1) is altered.

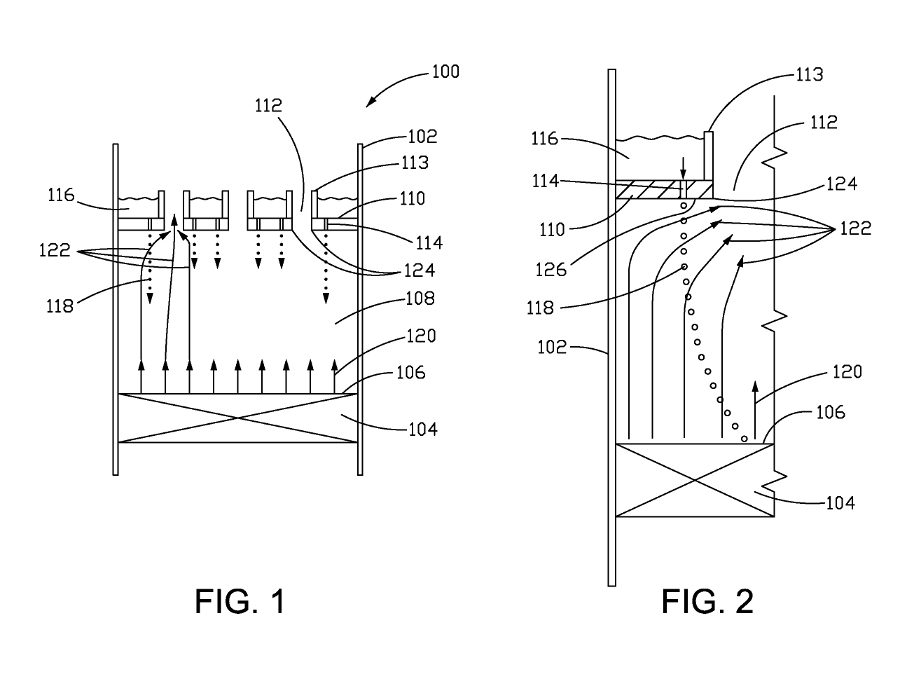

### DETAILED DESCRIPTION

Aspects of the current invention relate to liquid distribution over a surface of mass transfer devices, and in particular, for separation columns where uniform distribution of the falling liquid is critical and may impact the device's efficiency significantly. Aspects of the present invention are applicable to all style distributors, including, but not limited to, thin wall trough style and thick plate style liquid distributors, but are particularly beneficial for wide trough style liquid distributors or in the case where a high density hole pattern is used, for example, more than 200 holes per square meter of the mass transfer device area. Aspects of the current invention are specifically useful for minimizing liquid maldistribution on the packing surface. Further, aspects of the current invention may be particularly useful when high capacity structured packing is utilized and, therefore, high vapor flow rates in the mass transfer device are present.

Applicants determined that deflection of a free falling liquid stream greatly depends on the distance between the liquid distribution apertures or holes located on the distributor and the edge of the riser. Applicants found that less deflection occurred when the liquid distribution apertures or holes were positioned further away from the edge of the riser.

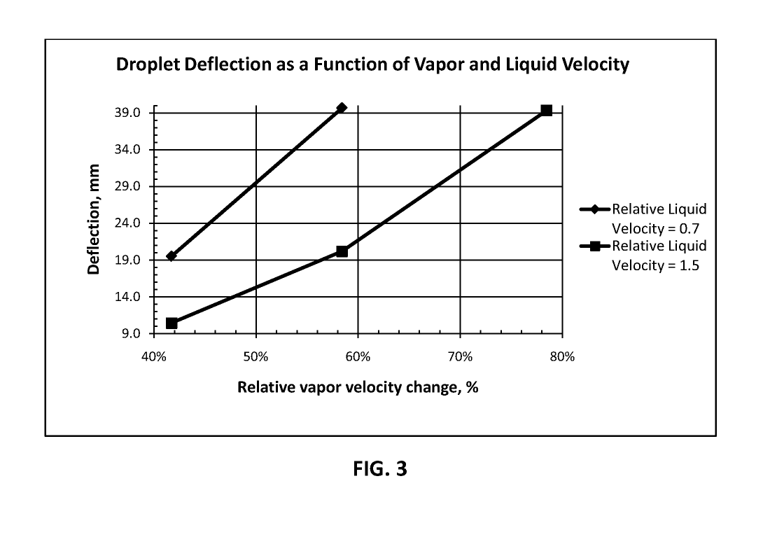

The effect of the vapor flow on liquid trajectory was evaluated using both theoretical and experimental means. A mathematical model was built to evaluate possible droplet deflection in the spacing of a column zone. This model was built using computational fluid dynamics (CFD) techniques. Commercially available code FLUENT was used to construct the model. The liquid deflection was calculated as a function of the vapor velocity as illustrated in FIG. 3. Modeling predictions were validated by comparing the deflection results obtained with experimental measurements made using air and water. An agreement between modeling and experimental results was found. As illustrated in FIG. 3 and Table 1, substantial liquid deflection may occur when the vapor velocity of the ascending vapor is relatively high.

TABLE 1

| Relative Vapor | | Liquid |
|---|---|---|
| Velocity | Relative Liquid | Deflection |
| % | Velocity | mm |
| 42% | 0.7 | 19.5 |
| 58% | 0.7 | 39.6 |
| 78% | 0.7 | — |
| 42% | 1.5 | 10.4 |
| 58% | 1.5 | 20.2 |
| 78% | 1.5 | 39.3 |

Measurement of the liquid deflection at a relative vapor velocity of 78% and a relative liquid velocity of 0.7 was not included in Table 1 because at such relative vapor and liquid velocities, the deflection was so great that the liquid deflected into other deflected liquid streams (coming from the other direction) in the same section causing inaccurate measurement of the liquid deflection. However, the liquid deflection at the relative vapor velocity of 78% and relative liquid velocity of 0.7 was greater than the liquid deflection at the relative vapor velocity of 58% and relative liquid velocity of 0.7. Applicants found that liquid deflection may be reduced if the initial velocity of the liquid droplets is increased. Nevertheless, the liquid deflection may be quite substantial even with a relatively high initial liquid velocity.

For example, a liquid droplet may be deflected nearly 36 mm from the desired vertical fall position when the vapor velocity is increased by approximately seventy-five percent (75%) as illustrated in FIG. 3. FIG. 3 also illustrates that the droplet deflection may exist even at relatively low vapor velocity, but the liquid maldistribution at the packing surface caused by such deflection may be tolerable for practical/commercial purposes.

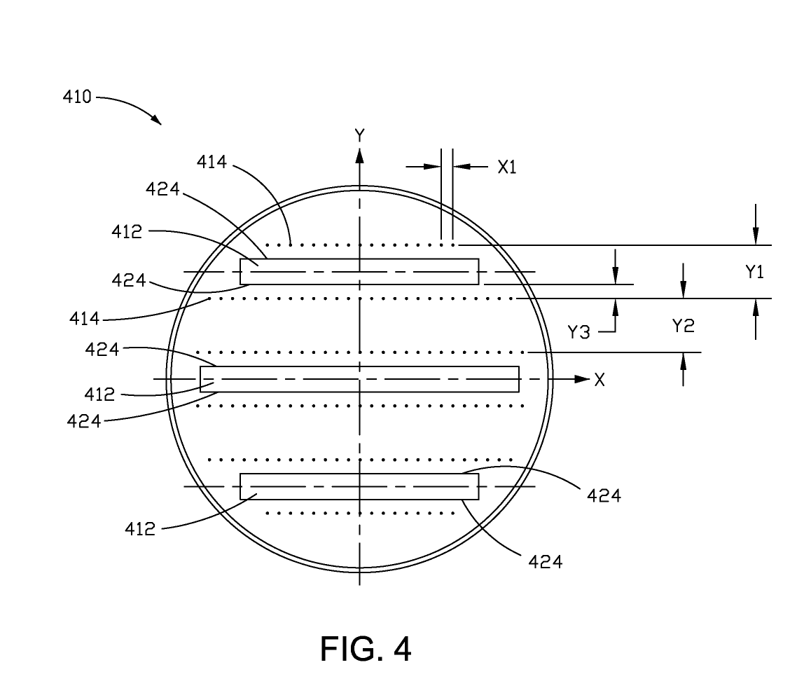

An example of a typical uniform distribution of liquid distribution apertures or holes 414 on a liquid distributor 410 is illustrated in FIG. 4. Rows of liquid distribution apertures or holes 414 are uniformly distributed on the liquid distributor 410 in two different directions along both an X and Y axes. Uniform distribution in each direction may be achieved, for example, by spacing the rows of liquid distribution apertures or holes 414 at a constant distance or hole pitch in each direction. In general, the hole pitch is defined as a distance between the adjacent liquid distribution apertures or holes or rows of liquid distribution apertures or holes and may or may not be the same in different distributor areas. For example, a constant or uniform distance between the neighboring liquid distribution apertures or holes 414 in the X direction (i.e. constant hole pitch in the X direction) is illustrated in FIG. 4. A constant or uniform distance between rows of liquid distribution apertures or holes in Y direction (i.e., a constant hole pitch in Y direction) is also illustrated in FIG. 4.

Again, traditionally it was customary to assume that the uniform distribution of the liquid distribution apertures or holes on the liquid distributor resulted in the same uniform distribution of the freely falling liquid on the mass transfer device surface. Indeed, utilization of the liquid distribution apertures or holes 414 illustrated in FIG. 4 does provide uniform, or close to the uniform liquid distribution on the mass transfer device surface when vapor velocity is substantially small, however, as the vapor velocity increases in the mass transfer column, the deflection of the droplets or liquid streams towards the center of the risers greatly increases leading to liquid maldistribution at the packing surface. Thus, at certain vapor velocities, that liquid maldistribution becomes severe enough such that the column performance is adversely affected.

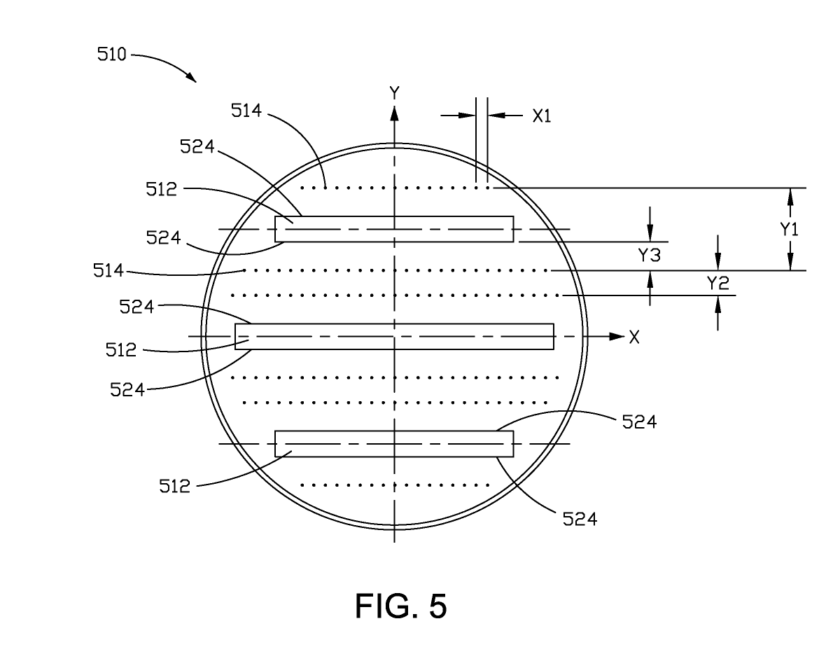

Applicants found that reduction in droplets or liquid stream deflections may be achieved when the distance between the riser edge 424 and the adjacent rows of liquid distribution apertures or holes 414 is increased. Thus, the constant hole pitch of the rows of liquid distribution apertures or holes 414 in Y direction, as shown in FIG. 4, was changed to a non-uniform or non-constant hole pitch as illustrated in FIG. 5.

FIG. 5 illustrates an exemplary embodiment of a non-uniform hole pitch distribution of liquid distribution apertures or holes 514 in the direction perpendicular to the length of the riser 512. As illustrated in FIG. 5, the distance between the rows of liquid distribution apertures or holes 514 positioned on opposite sides of each riser 512 is depicted as a distance Y1. The distance between adjacent rows of liquid distribution apertures or holes 514 positioned between two adjacent risers 514 is depicted as Y2. The distance between the riser edge 524 and the adjacent rows of liquid distributor apertures or holes 514 is depicted as Y3.

As illustrated in FIG. 5, the distance Y1 is greater than the distance Y2. For comparison purposes, the distance between the risers 412, 512 on the liquid distributors 410, 510 was kept constant in both FIGS. 4 and 5. In FIG. 5, the rows of liquid distribution apertures or holes 514 between the risers 512 were shifted closer to each other (i.e., the distance Y2 was decreased) and further away from the riser edges 524 (i.e., the distance Y3 was increased) as compared to the position of the liquid distribution apertures or holes 414 illustrated in FIG. 4. Changes in falling liquid trajectories of the droplets is observed as the result of such a shift of the rows of liquid distribution apertures or holes 514 away from the riser edges 524.

First, because the liquid distribution apertures or holes 514 were moved away from the riser edges 524, the falling droplets from the liquid distributor 510 of FIG. 5 may be distributed non-uniformly on the mass transfer device surface when the vapor velocity is substantially low because there is minimal liquid stream deflection from the initial liquid injection position when the vapor velocity is minimal. It is important to note that while mass transfer columns, and specifically air separation columns, are typically designed to operate at a maximum or close to a maximum capacity in the range of approximately 80%-100% of the designed column capacity, a mass transfer column, such as an air separation column, may be operated below such range in certain circumstances, thus, the vapor velocity is minimal, leading to non-uniform distribution. However, when such mass transfer columns are operated at such low production rates, the column performance is not likely to be subject of concern. At the same time, as the mass transfer column throughput increases in columns operating at high or maximum capacity, the deflection of droplets or liquid streams towards the center of the risers will result in a more uniform liquid distribution on the packing surface.

Such uniform liquid distribution is achieved as a result of the increased vapor velocity inside the column section (i.e., the increased vapor velocity causes more liquid deflection, however, the liquid distribution apertures or holes 514 are positioned on the liquid distributor 510 to combat the liquid deviation caused by such increases in the vapor velocity). Hence, the resultant deviation of the droplets from the desired uniform distribution position will be lowered or even eliminated completely.

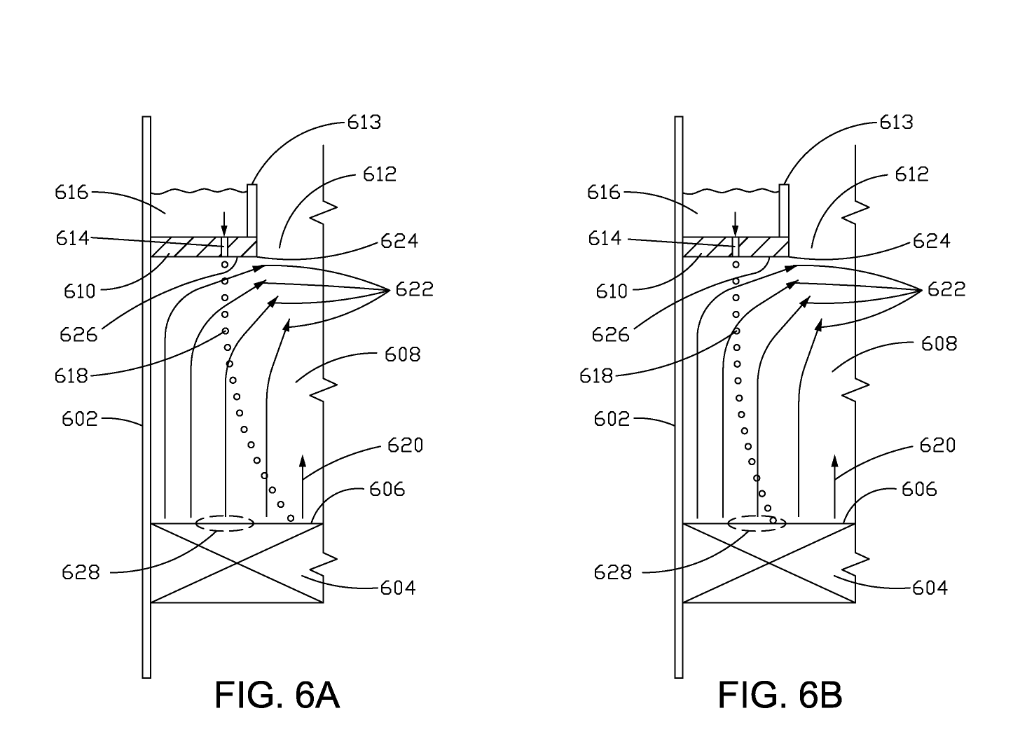

Indeed, the deviation from the desired liquid distribution position on the packing surface is the algebraic sum of the distances between the liquid desired fall position or target area on the packing surface and the actual liquid fall position on the packing surface. The liquid deflection is a directional difference of the liquid injection point and the liquid fall position on the packing surface. Therefore, a shift of the rows of liquid distribution apertures or holes may be calculated and arranged in such a way that such arrangement of the liquid distribution apertures or holes 514 compensates for the deviations from the desired position on the packing surface considering the existence of the liquid deflection. This arrangement of the liquid distribution apertures or holes 614 is illustrated in FIGS. 6A and 6B.

FIG. 6A illustrates how liquid deflection causes the droplets or liquid streams 618 to reach the surface of the packing 606 at a point outside of or away from a target area 628 or the area on the surface of the packing 606 where the droplets were intended to land or reach absent any force acting on the droplets 618 from the turning vapor streams 622. FIG. 6B illustrates that when the liquid distribution apertures or holes 614 on a liquid distributor 610 are moved away from the riser 612 the droplets 618 tend to fall within the target area 628. The droplets 618 fall within the target area 628 because of at least two reasons: (1) as a result of the movement of the liquid distribution apertures or holes 614 away from the riser 612 (as illustrated in FIG. 6B moving the liquid distributor aperture and hole 614 to the left of the original aperture and hole 614 illustrated in FIG. 6A), the droplets 618 fall on the packing surface 606 closer to or in the desired target area 628 as a result of the movement of the liquid distribution apertures or holes 614; and (2) movement of the liquid distribution apertures or holes 614 away from the riser 612 results in the droplets 618 falling on the packing surface 606 closer to or in the desired target area 628 as a result of the lesser forces attributable to the turning vapor streams 622 acting on the falling droplets 618. As previously mentioned, droplets 618 discharged from the liquid distribution apertures or holes 614 positioned further away from the riser edge 624 will experience less force acting upon them from the ascending vapor streams (the vapor streams 120 and turning vapor streams 122 collectively). Indeed, the closer the ascending vapor streams are to the riser opening, the faster such ascending vapor streams will move. The faster moving streams then interact with the falling droplets 618 with a greater force. Therefore, the closer the droplets 618 are injected to the riser edge 624, the greater the deflection of the droplets 618 should be expected as such droplets 618 fall through the spacing 608.

The same logic described above may also be used when the constant hole pitch in the X direction may be altered to a non-uniform hole pitch in X direction between all or some of the holes to combat liquid deviation in the X direction. Such alteration of the hole pitch in the X direction may be useful, for example, in cases where the columns have relatively small diameters and when the length of the risers do not protrude all the way across the column from one side to the other.

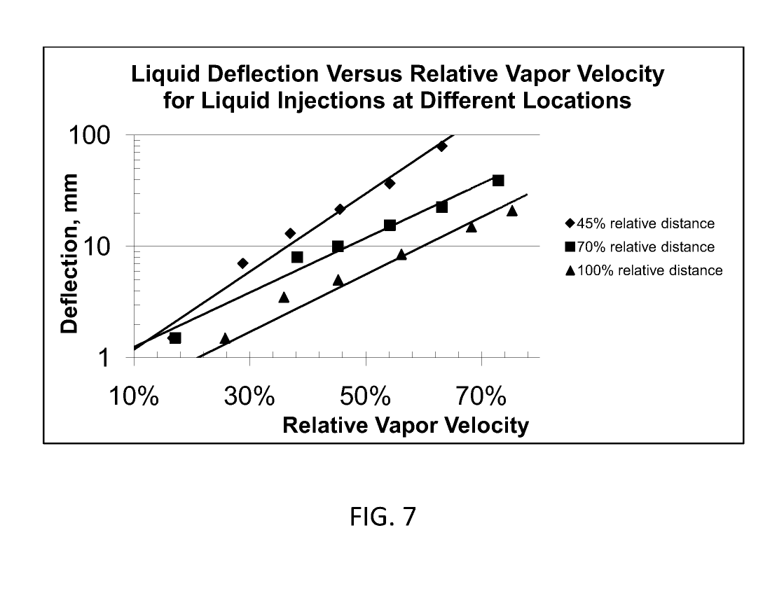

FIG. 7 illustrates how liquid deflection versus relative vapor velocity for liquid injections at different liquid distributor locations. As illustrated in FIG. 7, liquid deflection decreases as the relative distance from the riser edge to the liquid distribution apertures or holes increases. For example, the same deflection of about 15 mm was observed for a liquid droplet at a relative velocity of approximately 37% and 68% respectively when the relative distance from the riser to the liquid distribution aperture or hole was changed from 45% to 100% respectively. Therefore, while deflection still occurs in both cases, the deflection is dramatically lower during higher vapor velocity conditions when the liquid distribution apertures or holes are placed away from the riser edges.

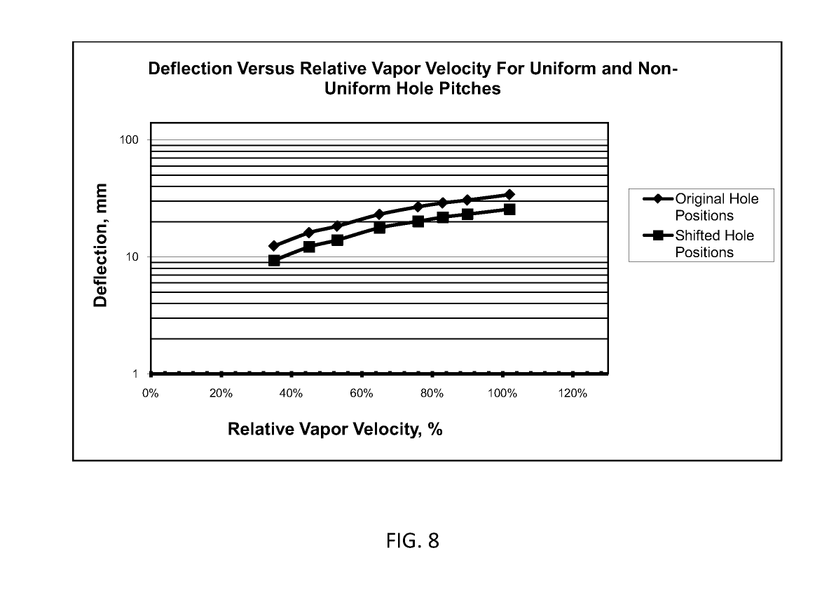

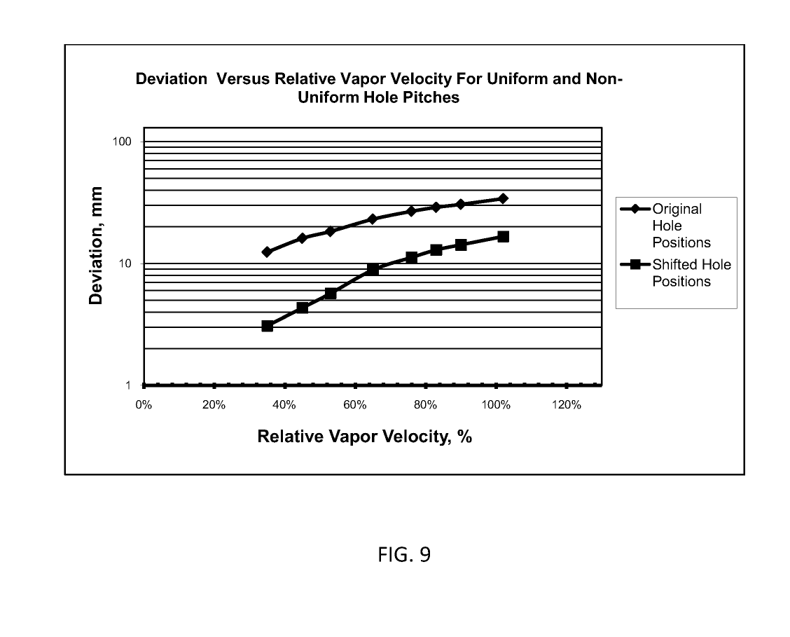

Table 2 in conjunction with FIGS. 8 and 9 illustrate the differences in liquid deflection and deviation in a mass transfer column that has a liquid distributor of FIG. 4 with uniform or constant hole pitch and the liquid distributor of FIG. 5 having non-uniform hole pitch in the Y direction, where the ratio of Y2/Y1 was approximately 80%, and where the relative liquid velocity and spacing height (H) remained constant and the relative vapor velocity was increased.

TABLE 2

| | |
|---|---|
| Deflection relative to | |
| injection point | Deviation from |
| Target Area (mm) | Target Area (mm) |

| | | FIG. 5 | | FIG. 5 |
|---|---|---|---|---|
| | FIG. 4 | Non- | FIG. 4 | Non- |
| Relative | Uniform | Uniform | Uniform | Uniform |
| Vapor | Hole | Hole | Hole | Hole |
| Velocity | Pitch | Pitch | Pitch | Pitch |
| 35% | 12.4 | 9.3 | 12.4 | 3.1 |
| 45% | 16.1 | 12.2 | 16.1 | 4.3 |
| 53% | 18.3 | 13.9 | 18.3 | 5.7 |
| 65% | 23.1 | 17.7 | 23.1 | 8.8 |
| 76% | 26.8 | 20.1 | 26.8 | 11.2 |
| 83% | 28.9 | 21.8 | 28.9 | 12.9 |
| 90% | 30.5 | 23.1 | 30.5 | 14.2 |
| 102% | 34.0 | 25.5 | 34.0 | 16.6 |

As illustrated in Table 2 and FIG. 8, it was found that there was less liquid deflection relative to the injection point target of the liquid distributor of FIG. 5 where the hole position was shifted versus the liquid distributor of FIG. 4 having uniform hole distribution. Moreover, it was found that the liquid deviation from the desired fall position or target area was significantly better for the liquid distributor of FIG. 5 versus the liquid distributor of FIG. 4. As illustrated in FIG. 9, the non-uniform holes pattern supports designed mass transfer device or separation column performance up to the relative vapor velocity of 102% whereas the case with uniform holes pattern supports high liquid maldistribution already in the vicinity of 50%-55% of the relative vapor velocity.

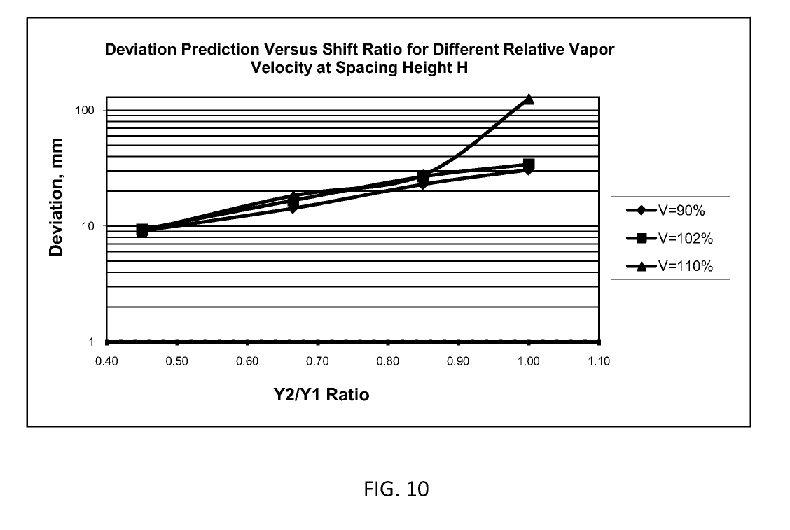

Table 3 in conjunction with FIG. 10 illustrates the differences in deviation from the target position for a spacing height H as the hole shift ratio (Y2/Y1) is changed.

TABLE 3

| | Deviation from Target | | |
|---|---|---|---|
| | Position (mm) | | |
| | Relative | Relative | Relative |
| | Vapor | Vapor | Vapor |
| Shift Ratio | Velocity | Velocity | Velocity |
| Y2/Y1 | (90%) | (102%) | (110%) |
| 0.45 | 9.1 | 9.3 | 9.1 |
| 0.67 | 14.2 | 16.6 | 18.3 |
| 0.85 | 22.9 | 26.7 | 27.5 |
| 1.00 | 30.5 | 34.0 | 124.7 |

As illustrated in Table 3, at a spacing height of H, the shift ratio of 0.45 led to the least deviation from the target position as the relative vapor velocity was increased from 90% to 110%.

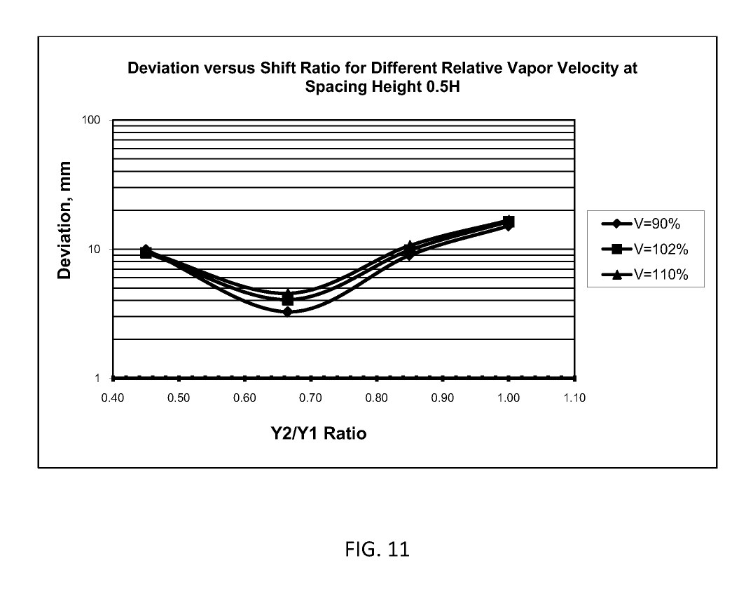

Table 4 in conjunction with FIG. 11 illustrates the differences in deviation from the target position for a spacing height 0.5(H) as the hole shift ratio (Y2/Y1) is altered.

TABLE 4

| | Deviation from Target | | |
|---|---|---|---|
| | Position (mm) | | |
| | Relative | Relative | Relative |
| | Vapor | Vapor | Vapor |
| Shift Ratio | Velocity | Velocity | Velocity |
| Y2/Y1 | (90%) | (102%) | (110%) |
| 0.45 | 9.8 | 9.4 | 9.6 |
| 0.67 | 3.3 | 4.1 | 4.5 |
| 0.85 | 8.9 | 9.8 | 10.6 |
| 1.00 | 15.1 | 16.3 | 16.7 |

As illustrated in Table 4, the deviation from the target position remained relatively low with shift ratios ranging from 0.45 to 0.85, and particularly at the shift ratio of 0.67 as the relative vapor velocity was increased from 90% to 110%. In another embodiment, liquid distribution apertures or holes and the rows of liquid distribution apertures or holes located next to the column walls may be shifted for the reasons other than obtaining uniform or non-uniform hole pitch patterns. These shifts may be associated with the interaction of the fluid streams (i.e., ascending vapor and falling liquid streams, and the column walls).

The exemplary embodiments may be utilized alone or in concert with shielding technology, for example.

While aspects of the present invention have been described in connection with the preferred embodiments of the various figures, it is to be understood that other similar embodiments may be used or modifications and additions may be made to the described embodiment for performing the same function of the present invention without deviating therefrom. The claimed invention, therefore, should not be limited to any single embodiment, but rather should be construed in breadth and scope in accordance with the appended claims. For example, the following aspects should also be understood to be a part of this disclosure:

1. A liquid distributor for distribution of a liquid in a mass transfer column, comprising:
a first riser, having a first riser width;
a first plurality of liquid distribution apertures positioned adjacent to and at a first distance from a first edge of the first riser;
a second plurality of liquid distribution apertures positioned adjacent to and at a second distance from a second edge of the first riser;
a second riser, having a second riser width;
a third plurality of liquid distribution apertures positioned adjacent to and at a third distance from a first edge of the second riser; and
a fourth plurality of liquid distribution apertures positioned adjacent to and at a fourth distance from a second edge of the second one riser;
wherein the second plurality of liquid distribution apertures are adjacent to and at a fifth distance from third plurality of liquid distribution apertures, and wherein the fifth distance between the second and third plurality of liquid distribution apertures is less than the first distance, the second distance, and the first riser width combined.

2. The liquid distributor of claim 1, wherein the mass transfer column is an air separation column.

3. The liquid distributor of claim 1, wherein the first plurality of liquid distribution apertures, the second plurality of liquid distribution apertures, the third plurality of liquid distribution apertures, and the fourth plurality of liquid distribution apertures have a constant hole pitch

4. A method for the distribution of a liquid in a mass transfer column, comprising the steps of:
a. introducing the liquid into an upper portion of the mass transfer column;
b. positioning within the mass transfer column as least one mass transfer column section;
c. positioning within the at least one mass transfer column section a liquid distributor to receive a downwardly flowing stream of liquid and an upwardly flowing stream of vapor, the liquid distributor comprising:
i. a first riser, having a first riser width;
ii. a first plurality of liquid distribution apertures positioned adjacent to and at a first distance from a first edge of the first riser;
iii. a second plurality of liquid distribution apertures positioned adjacent to and at a second distance from a second edge of the first riser;
iv. a second riser, having a second riser width;
v. a third plurality of liquid distribution apertures positioned adjacent to and at a third distance from a first edge of the second riser; and
vi. a fourth plurality of liquid distribution apertures positioned adjacent to and at a fourth distance from a second edge of the second one riser;
wherein the second plurality of liquid distribution apertures are adjacent to and at a fifth distance from third plurality of liquid distribution apertures, and wherein the fifth distance between the second and third plurality of liquid distribution apertures is less than the first distance, the second distance, and the first riser width combined,
d. collecting the downwardly flowing stream of liquid from the upper portion of the mass transfer column on the first surface of the liquid distributor;
e. passing the upwardly flowing stream of vapor from the lower portion of the mass transfer column through the risers of the liquid distributor; and
f. distributing the downwardly flowing stream of liquid from at least one liquid distribution aperture in the liquid distributor on to a packing.

5. The method of claim 3, wherein the packing is structured packing.

6. The method of claim 3, wherein the mass transfer column is an air separation column.
